(19) United States
(12) Patent Application Publication
(10) Pub. No.: US 2025/0298402 A1
(43) Pub. Date: Sep. 25, 2025

(54) SYSTEM AND METHOD FOR OPERATING LABORATORY BASED ON MODULAR EXPERIMENT PROCESS

(71) Applicant: KOREA INSTITUTE OF SCIENCE AND TECHNOLOGY, Seoul (KR)

(72) Inventors: SangSoo HAN, Seoul (KR); Donghun KIM, Seoul (KR); Hyukjun YOO, Seoul (KR)

(73) Assignee: KOREA INSTITUTE OF SCIENCE AND TECHNOLOGY, Seoul (KR)

(21) Appl. No.: 18/741,132

(22) Filed: Jun. 12, 2024

(30) Foreign Application Priority Data
Mar. 20, 2024 (KR) 10-2024-0038420

(51) Int. Cl. G05B 19/418

(52) U.S. Cl. CPC G05B 19/41865; G05B 2219/25058

(57) ABSTRACT

A laboratory operation system performs experiment processes of multiple modules for each the multiple job objects based on process conditions of the experiment processes of the multiple modules presented by the multiple job objects according to an execution sequence of the multiple job objects generated from multiple job scripts that record name of each of multiple modules selected by a user among multiple modules into each of which multiple unit processes performed in a laboratory, is modularized as each experiment process by grouping the multiple unit processes, and thus, the user may automatically perform a desired experiment without the user's involvement by simply selecting some of the multiple modules.

### CROSS-REFERENCE TO RELATED APPLICATION

This application is based on and claims priority under 35 U.S.C. § 119 to Korean Patent Application No. 10-2024-0038420 filed on Mar. 20, 2024, in the Korean Intellectual Property Office, the disclosure of which is incorporated by reference herein in its entirety.

### BACKGROUND

The present disclosure relates to a system and method for operating a laboratory.

Research and development on an unmanned laboratory, in which experiments are conducted without people due to fire accidents or explosions caused by various experiments conducted in the laboratory, are being actively conducted to ensure the safety of laboratory users. A operating system of the general unmanned laboratory uses a platform constructed by sequentially arranging a small number of experiment processes suitable for a specific application. However, although the platform is suitable for performing experiments by one user, the platform is a static system in which only a few experiment processes are aligned for the specific application. Therefore, it is difficult to conduct various experiments reflecting various applications of several users.

### SUMMARY

The present disclosure provides a laboratory operation system and method that may modularize multiple unit processes as each experiment process by grouping the multiple unit processes such that a user automatically performs a desired experiment without user's involvement by simply selecting a module and multiple experiments desired by several users are quickly completed. The present disclosure is not limited to the technical aspects described above, and other technical aspects may be derived from the description below.

According to an aspect of the present disclosure, a laboratory operation system includes an interface node configured to generate a job script that records name of each of multiple modules selected by a user among multiple modules into each of which multiple unit processes performed in a laboratory, is modularized as each experiment process by grouping the multiple unit processes, a master node configured to generate multiple job objects corresponding to multiple job scripts from the multiple job scripts including the generated job script and schedule an execution sequence of the generated multiple job objects, and multiple module nodes configured to perform the experiment process of each of the multiple modules for each of the multiple job objects based on process conditions of the experiment process of each of the multiple modules presented by each of the multiple job objects according to the execution sequence of the multiple job objects.

The master node may schedule the execution sequence of the generated multiple job objects generated based on an available resource amount of at least one experimental device used in an experiment process of a module to be first executed among the multiple modules of the multiple job objects.

The master node may schedule the execution sequence of the generated multiple job objects according to a sequence in which the generated multiple job objects satisfy a condition for an available resource amount of at least one experimental device used in the experiment process of the module to be first executed.

The master node may schedule the execution sequence of the generated multiple job objects according to a sequence in which the generated multiple job objects satisfy a condition for the available resource amount of the at least one experimental device used in the experiment process of the module to be first executed and whether the module to be first executed owns a task causing a bottleneck.

The master node may include a job scheduler configured to schedule the execution sequence of the generated multiple job objects in a method of repeating a process of storing multiple job identifications (IDs) assigned to the multiple job objects in a waiting queue according to a generation sequence of the multiple job objects, and moving, to an executing queue, a job ID that first satisfies the condition for the available resource amount of at least one experimental device used in the module to be first executed among multiple IDs stored in the waiting queue, and at least one job object to which at least one job ID stored in the executing queue is assigned may be executed in a sequence in which the at least one job ID is stored in the executing queue.

The job scheduler may include a job trigger configured to schedule the execution sequence of the generated multiple job objects in a method of repeating a process of moving, to the executing queue, a job ID that first satisfies the condition on an available resource amount of at least one experimental device used for the module to be first executed among the multiple IDs stored in the waiting queue and whether the module to be first executed owns a task causing a bottleneck.

The laboratory operation system may further include a resource manager configured to receive, from each of the multiple module nodes, information of each module node including an available resource amount of at least one experiment device used in the experiment process of each of the multiple modules performed by each of the multiple module nodes and configured to update the available resource amount of the at least one experimental device used in the experiment process of each of the multiple modules performed by each of the multiple module nodes according to the received information of the each module node, and the job scheduler may repeat a process of reading the available resource amount of the at least one experimental device used for the module to be first executed from the information of the each module node updated by the resource manager, and moving a job ID that first satisfies a condition for the read available resource amount to the executing queue.

The interface node may select a model presenting a process condition of the experiment process of each of the selected multiple modules according to information input by a user and generate the job script that records the process condition of the experiment process according to the selected model, and the master node may generate a job object including the selected model and determine the process condition of the experiment process of each of the multiple modules presented by the model included in the generated job object as a process condition of an experiment process of each of the multiple modules of the generated job object.

When the selected model is a manual model that manually determines the process condition of the experiment process of each of the selected multiple modules and presents the manually determined process condition, the master node may determine values of multiple process parameters of each experiment process recorded in the generated job script as values of multiple process parameters of the experiment process of each of the selected multiple modules.

When the selected model is an automatic model that automatically determines the process condition of the experiment process of each of the selected multiple modules and presents the automatically determined process condition, the master node may determine values of multiple process parameters of each experiment process predicted by an artificial intelligence model corresponding to the automatic model as values of multiple process parameters of the experiment process of each of the selected multiple modules.

The master node may include a job scheduler configured to generate the selected model, generate a process database in which information representing the experiment process of each of the selected multiple modules is recorded, and generate a job object including the generated model and the generated process database, and the information representing the experiment process of each of the selected multiple modules may include an execution sequence of the multiple modules and an execution sequence of multiple tasks for each module according to the information input by the user.

The master node further may include a task generator configured to generate multiple task recipes corresponding to recipes of multiple unit processes corresponding to the experiment process of each of the selected multiple modules for each of the selected multiple modules based on the process condition presented by the model of the generated job object and information recorded in a process database of the generated job object, and a task scheduler configured to perform or stop a unit process according to each of the multiple task recipes generated for each of the multiple selected modules according to the available resource amount of the at least one experimental device used in the experiment process of each of the selected multiple modules.

The master node may further include a task generator configured to generate a task recipe corresponding to a recipe of each of the multiple unit processes of the experiment process of each of the selected multiple modules for each of the multiple tasks for each module based on the process condition presented by the model of the generated job object and information recorded in a process database of the generated job object, and a task scheduler configured to determine execution or stop of each task according to each of the multiple task recipes generated for each of the selected multiple modules according to the available resource amount of the at least one experimental device used in the experiment process of each of the selected multiple modules.

The master node may further include an action translator configured to determine multiple actions of at least one experimental device used in the each task recipe according to a resource amount of at least one experimental device allocated to each task determined by the execution and a process condition recorded in a task recipe of each task determined by the execution, and an action scheduler configured to schedule an execution sequence of the multiple determined actions according to whether identical experimental devices are used simultaneously during execution of different job objects.

One module node that performs an experiment process of one module among the multiple modules of the each job object among the multiple module nodes may perform an experiment process of the one module by receiving multiple action names listed according to the execution sequence of the multiple actions and information for performing actions corresponding to the multiple action names for each task of the one module from the master node and by executing the actions corresponding to the multiple action names in a sequence in which the multiple action names are listed, according to the information for executing the actions corresponding to the multiple action names.

According to another aspect of the present disclosure, a laboratory operation method includes collecting multiple unit processes performed in a laboratory and generating a job script in which names of multiple modules selected by a user among multiple modules modularized into experiment processes are recorded, generating multiple job objects corresponding to multiple job scripts from the multiple job scripts including the generated job script and scheduling an execution sequence of the multiple generated job objects, and performing the experiment processes of the multiple modules for each of the multiple job objects based on process conditions of the experiment processes of the multiple modules presented by the multiple job objects according to the execution sequence of the multiple job objects.

According to another aspect of the present disclosure, there is provided a computer-readable recording medium in which a program causing a computer to execute the laboratory operation method is recorded.

### BRIEF DESCRIPTION OF THE DRAWINGS

Embodiments of the inventive concept will be more clearly understood from the following detailed description taken in conjunction with the accompanying drawings in which:

FIG. 1 is a modular experiment process structural diagram according to an embodiment of the present disclosure;

FIG. 2 is a configuration diagram of a laboratory operation system according to an embodiment of the present disclosure;

FIG. 3 is a flowchart of a laboratory operation method according to an embodiment of the present disclosure;

FIGS. 4A and 4B illustrate examples of job scripts according to a manual model of the present embodiment;

FIGS. 5A and 5B illustrate examples of job scripts according to an automatic model of the present embodiment;

FIG. 6 is a configuration diagram of a master node illustrated in FIG. 2;

FIG. 7 is a configuration diagram of a job scheduler illustrated in FIG. 3;

FIG. 8 is a table listing several commands that may be input to an interface node illustrated in FIG. 2;

FIG. 9 is an operation flowchart of a job scheduler illustrated in FIG. 6;

FIG. 10 is an operation flowchart of a job trigger 212 illustrated in FIG. 7; and

FIG. 11 is an operation flowchart of a job modeler illustrated in FIG. 7.

### DETAILED DESCRIPTION OF THE EMBODIMENTS

Hereinafter, embodiments of the present disclosure will be described in detail with reference to the drawings. Embodiments of the present disclosure relate to a laboratory operation system and method that may modularize multiple unit processes as each experiment process by grouping the multiple unit processes such that a user automatically performs a desired experiment without user's involvement by simply selecting a module and multiple experiments desired by several users are quickly completed. Hereinafter, the device and method are respectively briefly referred to as a “laboratory operation system” and a “laboratory operation method”.

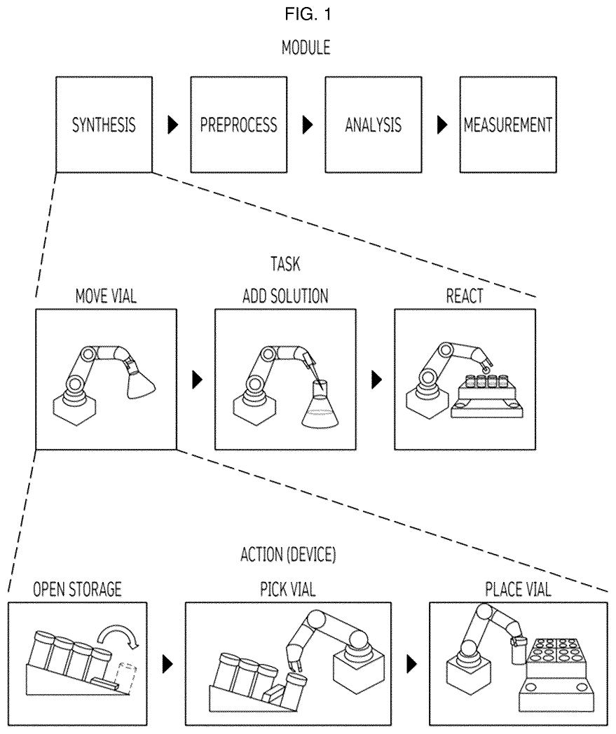

FIG. 1 is a modular experiment process structural diagram according to an embodiment of the present disclosure. Various experiments are performed in a laboratory. The laboratory is equipped with various experimental devices to perform various experiments. In the laboratory, several experiment jobs designated by several users are generally performed simultaneously. In the present embodiment, each experimental task refers to a combination of several experiment processes that may acquire experimental results desired by a user. Hereinafter, each experimental task designated by each user will be briefly referred to as a “job”.

There is often a case where the same experimental device is used in different experiment processes. When an experimental device is used in an experiment process, the experimental device may not be used in other experiment processes. Accordingly, in order for various experiment processes to be completed quickly, an execution sequence of various experiment processes needs to be appropriately scheduled. In general, the execution sequence of various experiment processes is scheduled by a laboratory manager or user. A laboratory of the present embodiment is an unmanned laboratory in which the execution sequence of various experiment processes is automatically scheduled to perform an experiment without people. According to the present embodiment, not only the execution sequence of various experiment processes is automatically scheduled, but also information required to perform each experiment process is also automatically determined.

In order to automate the various experiment processes, the present embodiment modularizes a combination of multiple unit processes frequently used in a laboratory into one module by setting the combination of the multiple unit processes to one experimental process. That is, in the present embodiment, each module is obtained by modularizing multiple unit processes as each experiment process by grouping the multiple unit processes performed in a laboratory. According to the present embodiment, a combination of multiple unit processes for performing a specific experiment in a laboratory becomes a module corresponding to an experiment process for the specific experiment, and a combination of multiple modules selected by a user becomes an experimental task desired by the user. Referring to FIG. 1, a module of the present embodiment includes a synthesis module for performing a synthesis process, a pre-processing module for performing pre-processing process, an analysis module for performing an analysis process, and a measurement module for performing a measurement process.

The synthesis module may include, for example, a module representing an experiment process of synthesizing nanoparticles based on a solution process, a module representing an experiment process for synthesizing a crystal structure based on a powder process, and so on. The pre-processing module may include, for example, a module representing an experiment process of washing particles, a module representing an experiment process of making electrochemical catalyst ink, and so on. The analysis module may include, for example, a module representing an experiment process of performing X-ray diffraction (XRD) analysis, a module representing an experiment process of performing ultraviolet (UV)-Vis spectroscopy analysis, and so on. The measurement modules may include, for example, a module representing an experiment process of performing thermochemical measurement, a module representing an experiment process of performing electrochemical measurement, and so on.

Referring to FIG. 1, in the present embodiment, the experiment process of each module consists of multiple tasks. Each task of the present embodiment means each unit process. Each unit process of the present embodiment refers to each of multiple processes constituting each experiment process and is designed based on a process unit that is common among multiple experiment processes corresponding to multiple modules. For example, the module representing the experiment process of synthesizing the nanoparticles based on a solution process may perform multiple tasks including a chemical vial transfer process, a solution injection process, a synthesis reaction process, and so on.

A module representing an experiment process of synthesizing a crystal structure based on a powder process may perform multiple tasks including a chemical vial transfer process, a powder injection process, a heating reaction process, and so on. The module representing the experiment process of washing the particles may perform multiple tasks including a chemical vial transfer process, a solvent injection process, a centrifugation process, a solvent removal process, and so on. A module representing an experiment process of producing electrochemical catalyst ink may perform multiple tasks including a chemical vial transfer process, a solvent and binder injection process, a sonication process, a stirring process, and so on.

The module representing the experiment process of performing the XRD analysis may perform multiple tasks including a chemical vial transfer process, a powder injection process, a specimen manufacturing process, a specimen measurement process, a specimen removal process, and so on. The module representing the experiment process of performing the thermochemical measurement may perform multiple tasks including a measurement solvent injection process, a nitrogen purging process, a catalyst ink loading process, a measurement process, a reactor cleaning process, and so on.

Referring to FIG. 1, in the present embodiment, a unit process corresponding to each task may include multiple actions. For example, in the module representing the experiment process of synthesizing the nanoparticles based on the solution process, a task representing the chemical vial transfer process may include an action to open an entrance to a chemical vial storage, an action for a robot arm to pick a chemical vial, an action for the robot arm to place the chemical vial on a stirrer, and so on In the module, the solution injection process may include an action to set an operation value of a pump, an action to place a solution dispenser on a stirrer, an action to operate a pump.

In the module representing the experiment process of washing the particles, the task representing the chemical vial transfer process may include an action to transfer a chemical vial holder, an action for the robot arm to pick the chemical vial, an action for the robot arm to place the chemical vial on a stirrer, and so on. In the module, the centrifuge process may include an action to open a centrifuge, an action for a robot arm to place a chemical vial in the centrifuge, an action to close the centrifuge, an action to drive the centrifuge at a preset rpm, and so on.

Each action is expressed as data to control actions of experimental devices, such as a robot, a pump, a centrifuge, and so on. Action control of the experimental devices may include dynamic control such as robot movement control, static control such as setting an RPM value of a centrifuge, and so on Each task is expressed as a set of multiple action data, and each module is expressed as a set of multiple task data.

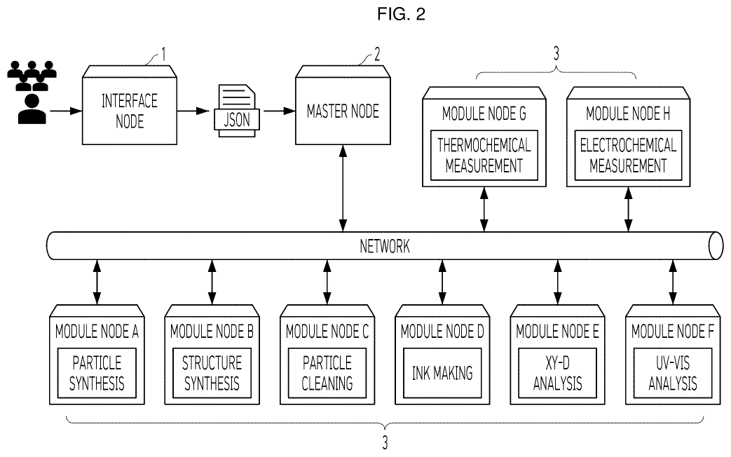

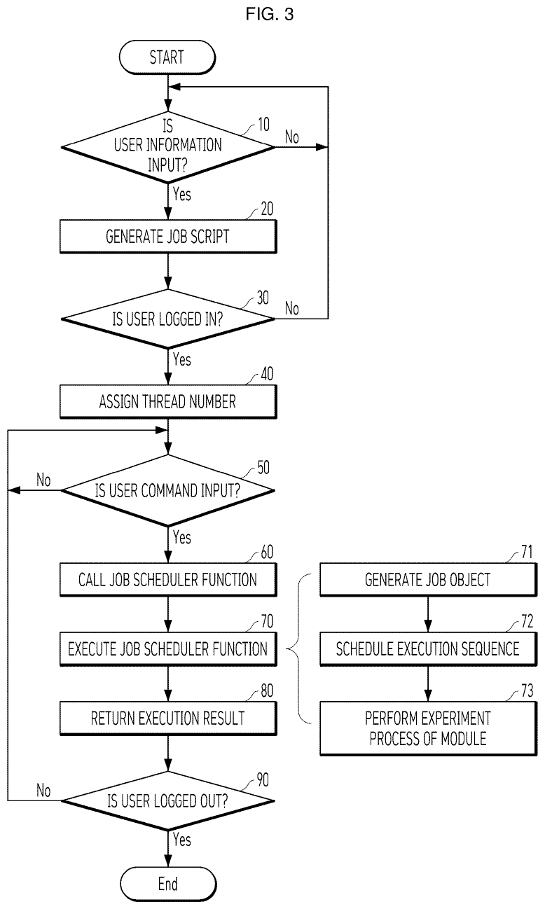

FIG. 2 is a configuration diagram of a laboratory operation system according to an embodiment of the present disclosure, and FIG. 3 is a flowchart of a laboratory operation method according to an embodiment of the present disclosure. Referring to FIG. 2, the laboratory operation system according to the embodiment may include an interface node 1, a master node 2, and multiple module node 3. In the present embodiment, each of multiple nodes is implemented by a separate computer, and the multiple nodes communicate with each other through a network. Some of the multiple nodes may be implemented by one computer. For example, the interface node 1 and the master node 2 may be implemented by one computer. Hereinafter, the laboratory operation system and laboratory operation method according to the present embodiment will be described with reference to FIGS. 2 and 3.

In step 10, the interface node 1 checks whether information for generating a job script is input by a user. When the information for generating the job script is input by the user as a result of the check in step 10, the processing proceeds to step 20. Otherwise, the processing returns to step 10. In step 20, the interface node 1 generates the job script according to the information input by the user in step 10. In step 30, the interface node 1 checks whether the user logs in to one of multiple job sections. In the present embodiment, multiple job sections are provided such that several users may simultaneously access the interface node 1 and generate job scripts at the same time. When the user logs in as a result of the check in step 30, the processing proceeds to step 40. Otherwise, the processing returns to step 10.

In the process of repeating step 10 to step 30, the user continuously inputs information for generating a job script into the interface node 1 until log-in to complete the job script desired by the user. As such, in step 20, the interface node 1 selects multiple modules corresponding to some of the multiple modules obtained by modularizing multiple unit processes as each experiment process by grouping the multiple unit processes, and generates a job script in which a name of each of the multiple modules selected by the user and the process conditions of the experiment process of each of the multiple modules selected by the user are recorded. The process conditions of the experiment process of each of the multiple modules selected by the user may be said to be process conditions of each experiment process indicated by the name of each of the multiple modules.

According to the present embodiment, a user may automatically perform an experiment desired by the user without user's involvement by simply selecting some of multiple modules obtained by modularizing multiple unit processes as each experiment process by grouping the multiple unit processes.

In the present embodiment, a model that presents process conditions of the experiment process of each module is divided into a manual model and an automatic model depending on whether the process conditions of each experiment process are manually determined by a user or whether the process conditions of each experiment process are automatically determined by an artificial intelligence model. The automatic model is further divided into several types of artificial intelligence models. A format of the job script is changed depending on which type of model is selected among several types of models that present the process conditions of each experiment process. That is, the interface node 1 selects a model presenting the process conditions of the experiment process of each of the multiple modules selected according to the information input by a user, and generates a job script in which the process conditions of each experiment process according to the selected model are recorded.

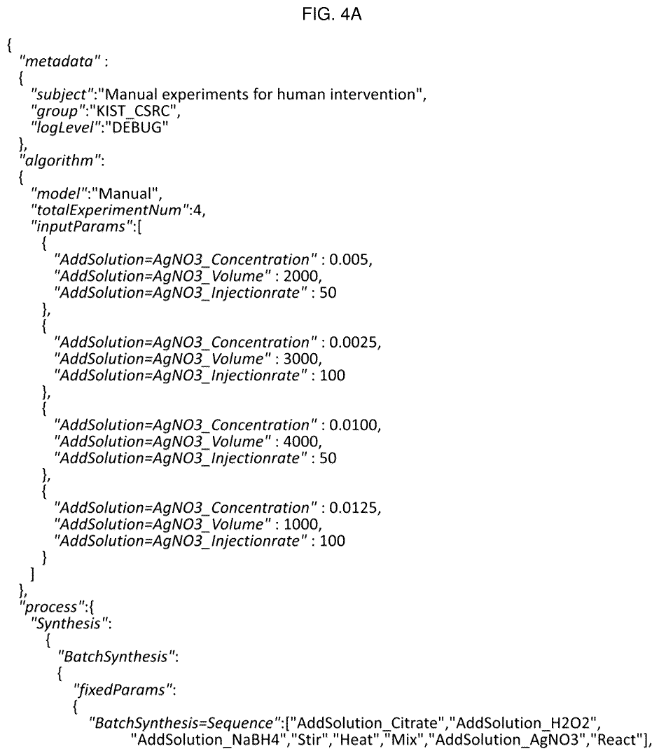

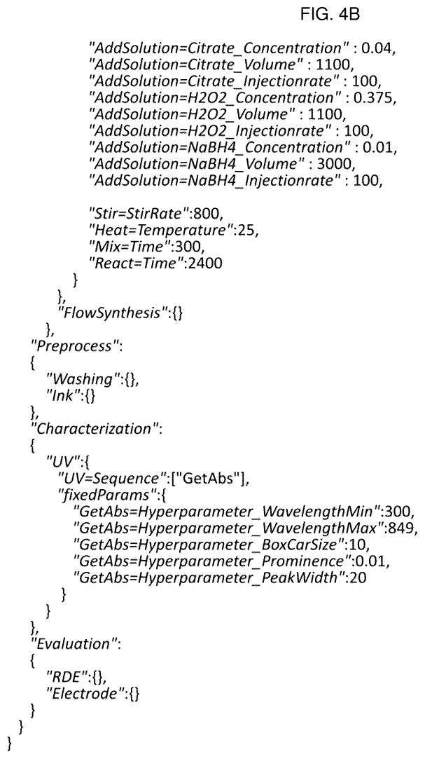

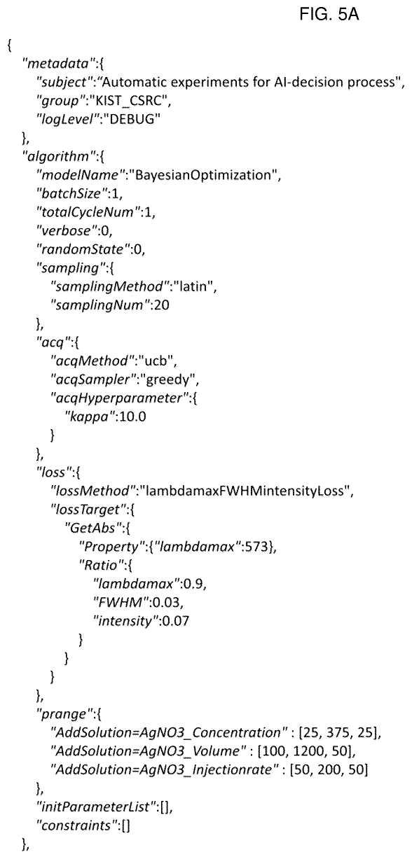

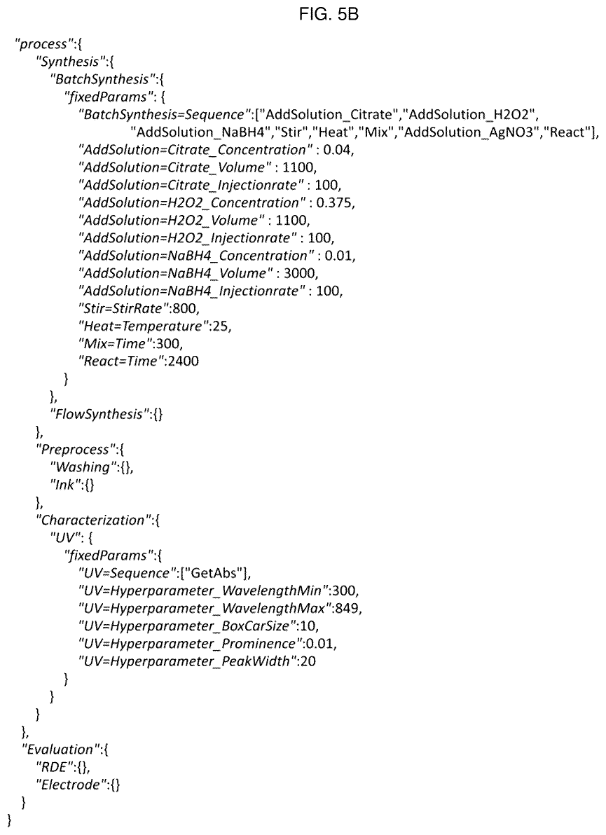

FIGS. 4A and 4B illustrate examples of job scripts according to the manual model of the present embodiment, and FIGS. 5A and 5B illustrate examples of job scripts according to the automatic model of the present embodiment. Process conditions of an experiment process of each module refer to various conditions that have to be set to perform an execution process thereof. A representative example of the process conditions of each experiment process may include multiple process parameter values used in each experiment process, such as concentration, volume, and an injection rate of several solutions used in each experiment process. In the present embodiment, the manual model refers to a model that manually determines process conditions of an experiment process for each of multiple modules selected by a user and presents the manually determined process conditions. The automatic model refers to a model that automatically determines the process conditions of the experiment process of each of the multiple modules selected by the user and presents the automatically determined process conditions.

A job script of the present embodiment has a JavaScript object notation (JSON) file format of a hierarchical structure. Regardless of the type of model, the first layer, which is the highest layer of the job script, includes a metadata layer in which metadata of each job for each user is recorded, an algorithm layer in which algorithm information of a model presenting process conditions of each module's experiment process is recorded, and a process layer in which process condition information of experiment processes of each of multiple modules used in each job for each user is recorded. Regardless of the type of model, the second layer of the metadata layer records an experiment title, a user's group, and a log file level of “DEBUG” or “INFO”.

In the job script of the manual model illustrated in FIGS. 4A and 4B, “manual” indicating that a model selected by a user is a manual model is recorded in a “model” of the second layer of the algorithm layer. The total number of experiments is recorded in “totalExperimentNum”, and at least one process parameter value that a user wants to experiment is recorded in “inputParams”. Each process condition includes one dictionary, and a format of “{task name]={process parameter name}” is recorded in one process condition.

In the job script of the manual model illustrated in FIGS. 4A and 4B, information on a module corresponding to synthesis is recorded in “synthesis” of the second layer of a process hierarchy. That is, names of modules, such as “BatchSynthesis” and “FlowSynthesis” are recorded in this third layer of the process layer and a sequence of module names becomes an execution order of modules. Additional module names may be added here. At least one process parameter value that a user wants to fix is recorded in “fixedParams” of the fourth layer. A task sequence of each module is recorded in “{Module Name}=Sequence” of the fifth layer. Respective process parameter values that a user wants to fix in the task of each module is recorded in the fifth layer as a format “{task name}={process parameter name}”.

Likewise, names of modules corresponding to preprocessing, for example, washing, catalyst ink making, and so on, are recorded in the third layer of “Preprocess” of the second layer. Likewise, names of modules corresponding to analysis, for example, UV-Vis analysis, and so on are recorded in the third layer of “Characterization” of the second layer. Likewise, names of modules corresponding to measurements, for example, rotating disk electrode (RDE) measurement, electrode measurement, and so on, are recorded in the third layer of “Evaluation” of the second layer. The remaining information of “Preprocess”, “Characterization”, and “Evaluation” of the second layer is also recorded in the same hierarchical structure as the second layer “Synthesis”. In this way, an execution sequence of multiple modules, an execution sequence of multiple tasks for each module, and process conditions fixed by a user are recorded in a process layer.

In the job script of the automatic model illustrated in FIGS. 5A and 5B, “BayesianOptimization” indicating that the model selected by a user is an automatic model which is a Bayesian optimization model is recorded a “model” in the second layer of the algorithmic hierarchy. Instead of the Bayesian optimization model, names of other types of artificial intelligence models, such as “DecisionTree” and “AdaBoost” may also be recorded. In the second layer, the number of repetitions of each experiment process performed in one cycle is recorded in “batchSize”. The total number of cycles performed in each experiment process is recorded in “totalCycleNum”. Visualization steps of each experiment process, for example, 0, 1, and 2 are recorded in “verbose”. random numbers required for learning an artificial intelligence model are recorded in “randomState”. initial sampling values are recorded in “sampling” before process parameter values of an artificial intelligence model are predicted. A sampling method is recorded in “samplingMethod” in the third layer, and an initial sampling number is recorded in “samplingNum”.

Design factors of an acquisition function for recommending the next process parameter values are recorded in “acq” in the second layer. The type of acquisition function is recorded in “acqMethod” in the third layer. For example, any one of “ei (expected improvement)”, “ucb (upper confidence bound)”, and “es (Entropy Search)” may be recorded. The type of sampling of an acquisition function is recorded in “acqSampler”. For example, either “greedy” or “capitalism” may be recorded. Hyperparameters of an acquisition function are recorded in “acqhyperparamater”. In the fourth layer, when “acqMethod is “ucb”, “acqHyperparameter” becomes “kappa”, and when “acqMethod” is “ei”, “acqHyperparameter” becomes “xi”.

Information on a loss function for a user to evaluate a material synthesized according to the present embodiment is recorded in “loss” in the second layer. The type of loss function is recorded in “lossMethod” in the third layer. Information on what material property a user wants as a result of an experiment is recorded in “loss Target”. Names of tasks from which physical properties are extracted are recorded in the fourth layer thereunder. For example, “GetAbs” that is a name of a task for acquiring absorbance may be recorded. Values of physical properties targeted by a user are recorded in “Property” in the fifth layer. For example, an overvoltage of catalyst, current density, a maximum absorption wavelength of display nanoparticles, and so on may be recorded. A weighted value of a loss function is recorded in “Ratio”. A key value of the sixth layer changes depending on the property that may be extracted from the fourth layer.

A range of process parameter values set by a user is recorded “prange” in the second layer. The artificial intelligence model predicts a process parameter value within the range. A key is recorded in a format “{task name}={process variable name}”, and the range of process parameter values follows a format of [{minimum value}, {maximum value}, {value interval}]. The process parameter values that a user wants to execute unconditionally are recorded in “initParameterList”. A range of constraints of a process design based on an artificial intelligence model is recorded in “Constraints” and is recorded in a format “{task name}={process parameter name}”. A process layer is the same as the job script of the manual model illustrated in FIGS. 4A and 4B and is replaced with the descriptions of FIGS. 4A and 4B.

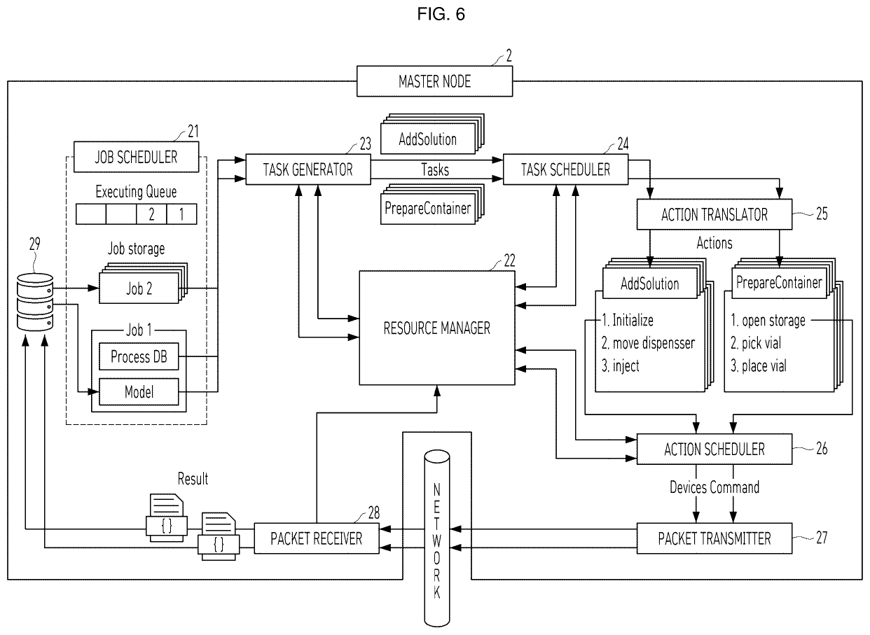

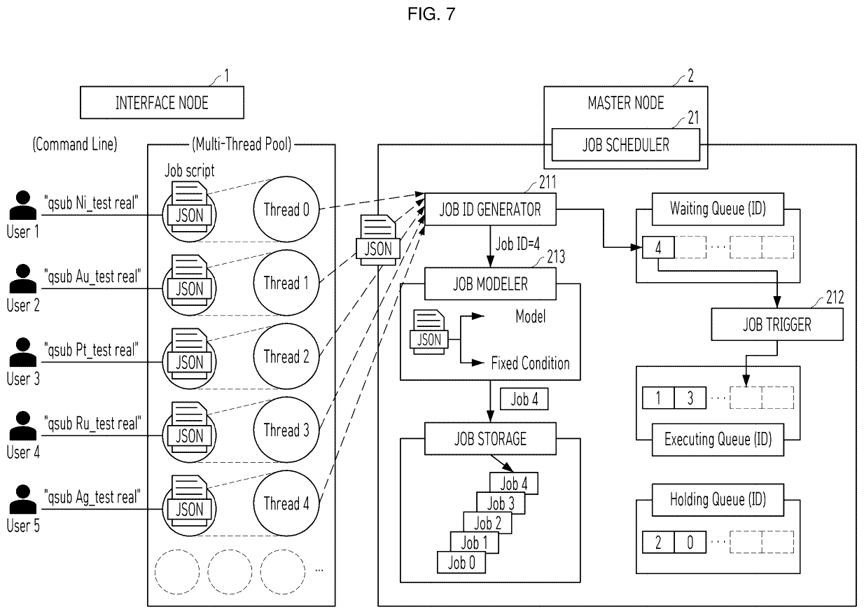

FIG. 6 is a configuration diagram of the master node 2 illustrated in FIG. 2. Referring to FIG. 6, the master node 2 includes a job scheduler 21, a resource manager 22, a task generator 23, a task scheduler 24, an action translator 25, an action scheduler 26, a packet transmitter 27, a packet receiver 28, and a storage 29. FIG. 7 is a configuration diagram of the job scheduler 21 illustrated in FIG. 3. Referring to FIG. 7, the job scheduler 21 includes a job ID generator 211, a job trigger 212, and a job modeler 213. Since a considerable amount of time is required to completely perform several experiment processes according to one job script, the laboratory operation system according to the present embodiment supports parallel processing of multiple job scripts requested by several users. In order to show parallel processing of the multiple job scripts, FIG. 7 illustrates the interface node 1 in addition to the job scheduler 21.

In step 40, the interface node 1 assigns at least one thread number among multiple thread numbers of a multi-thread pool to at least one user logged in in step 30. One thread number is assigned to each user. The present embodiment may process in parallel multiple commands input by multiple users by using Python's multi-thread pool. By doing this, the present embodiment may process in parallel multiple job scripts generated according to information input by multiple users. In step 50, the interface node 1 checks whether a command is input by a user to which a thread number is assigned in step 40. When a command is input by a user as a result of the check in step 50, the processing proceeds to step 60. Otherwise, the processing waits until the command is input by the user.

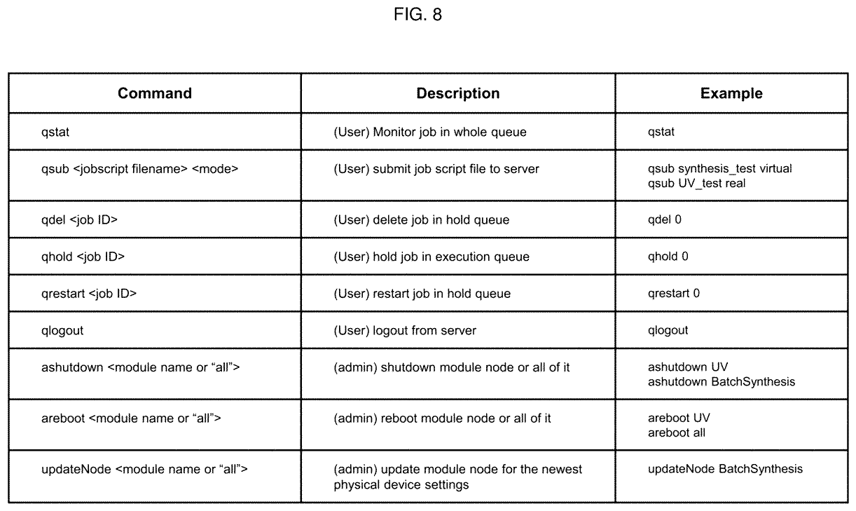

FIG. 8 is a table listing several commands that may be input to the interface node 1 illustrated in FIG. 2. Referring to FIG. 8, a user may input any one of commands “qstat”, “qsub”, “qdel”, “qhold”, “qrestart”, and “qlogout” to the interface node 1. A manager of the laboratory operation system according to the present embodiment may input any one of commands “ashutdown”, “areboot”, and “updateNode” to the interface node 1. An operation of the master node 2 according to each command is illustrated in FIG. 8.

In step 60, the interface node 1 calls a job scheduler function corresponding to a command input by a user in step 50 to the master node 2. In step 70, the master node 2 executes the job scheduler function called by the interface node 1 in step 60. In step 80, the master node 2 returns an execution result of the job scheduler function in step 70 to the interface node 1. For example, when the interface node 1 calls a job scheduler function corresponding to the command “qstat” input by a user, the master node 2 executes the job scheduler function by monitoring job identifications (IDs) stored in the entire queue and returns a result of the monitoring.

In step 90, the interface node 1 checks whether the user logs out of a job section. When the user logs out as a result of the check in step 90, the processing ends. Otherwise, the processing return to step 50. After calling the job scheduler function in step 60, the interface node 1 checks whether a user logs out in step 90, and when the user is in a log-in state, the interface node 1 checks whether a command is input by the user. This processing repeats until the user logs out.

When the interface node 1 calls a job scheduler function corresponding to the command “qsub <filename> <modetype>” input by a user, the master node 2 executes the job scheduler function by causing multiple module nodes 3 to perform an experiment according to the job script and returns a result of the experiment. When the interface node 1 calls a job scheduler function corresponding to a command “qdel <job id>” input by a user, the master node 2 executes the job scheduler function by deleting a job ID from a holding queue and returns a result indicating the deletion of the job ID.

When the interface node 1 calls a job scheduler function corresponding to a command “qhold <job id>” input by a user, the master node 2 executes a corresponding job scheduler function by moving a corresponding job ID from an executing queue to a holding queue and storing the corresponding job ID and returns a result notifying job ID holding. When the interface node 1 calls a job scheduler function corresponding to a command “qrestart <job id>” input by a user, the master node 2 moves a corresponding job ID from a holding queue to an executing queue and stores the corresponding job ID and returns a result notifying restart of the job ID. When the interface node 1 calls a job scheduler function corresponding to a command “qlogout” input by a user, the master node 2 executes logout of the user and returns a result notifying the logout.

As described above, a user may input qsub <filename> <modetype> to the interface node 1 to submit the job script generated in step 20 to the master node 2. Here, <filename> refers to a file name named by a user for the job script generated in step 20, and <modetype> refers to a string indicating whether the experiment performed according to the job script generated in step 20 is in a virtual experiment mode or an actual experiment mode. In this case, the master node 2 executes a corresponding job scheduler function by causing the multiple module nodes 3 to perform an experiment according to the job script generated in step 20, and each of the multiple module nodes 3 performs the experiment according to the job script generated in step 20 according to an instruction of the master node 2 and transmits a result of the experiment to the master node 2.

Specifically, in step 71, the master node 2 generates multiple job objects corresponding to multiple job scripts from the multiple job scripts including the job script generated by the interface node 1. The master node 2 generates one job object from one job script. That is, the interface node 1 may generate each of the multiple job scripts according to the information input by each of multiple users, and the master node 2 may generate each of the multiple job objects from each of the multiple job scripts. Each of the multiple job objects presents an experiment using a combination of multiple modules but may also present an experiment using a single module.

In step 72, the master node 2 schedules an execution sequence of the multiple job objects generated in step 71. According to the present embodiment, the master node 2 schedules the execution sequence of the multiple job objects generated in step 71 based on an available resource amount of at least one experiment device used in an experiment process of a module to be first executed among the multiple modules of each job object generated in step 71. Here, the available resource amount of each experimental device refers to the remaining resource amount that is currently available among the total resource amount of each experimental device. For example, when the experimental device is a stirrer capable of loading a total of 10 vials and the stirrer is currently loaded with three vials, the total resource amount of the experimental device is 10, and the available resource amount is 7.

In this way, the resources of several experimental devices provided in a laboratory may be optimally distributed and used such that multiple experiments desired by several users may be completed quickly by scheduling an execution sequence of multiple job objects based on the available resource amount of at least one experimental device used in an experiment process of a module to be first executed among multiple modules of each job object.

In step 73, the multiple module nodes 3 perform experiment processes for the multiple modules indicated by a process database of each job object for each job object based on process conditions of each experiment process of each of the multiple modules presented by a model of each job object according to an execution sequence of the multiple job objects scheduled by the master node 2 in step 72. Subsequently, each of the multiple module nodes 3 transmits performance results of respective experiment processes to the master node 2. In step 80, the master node 2 receives the performance results of the experiment processes from each of the multiple module nodes 3 and returns the performance results of the respective experiment processes to the interface node 1 as a result of the execution of the job scheduler function in step 70. Here, the multiple modules indicated by the process database of each job object means the multiple modules indicated by multiple module names recorded in the process database of each job object.

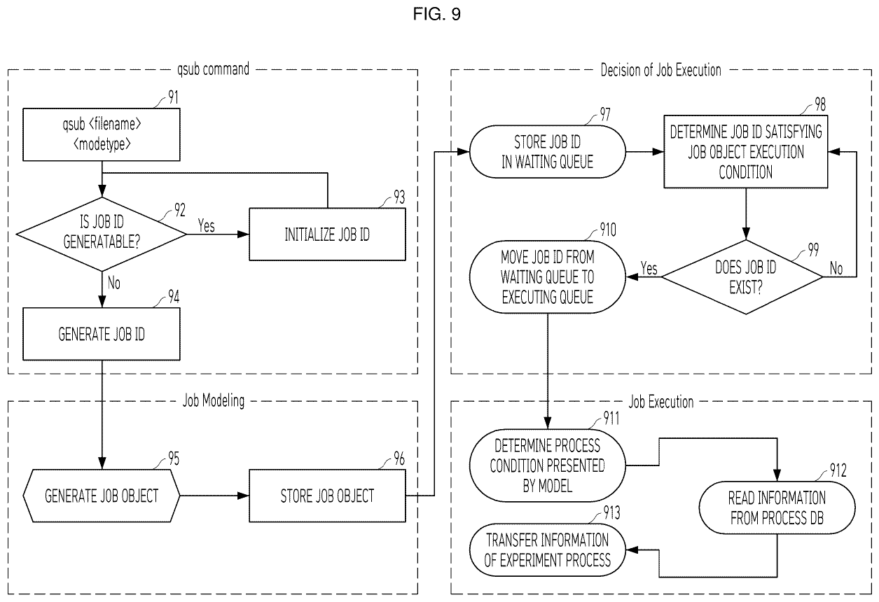

FIG. 9 is an operation flowchart of the job scheduler 21 illustrated in FIG. 6. Referring to FIG. 9, an operation of the job scheduler 21 illustrated in FIG. 6 is performed in a following sequence. In step 91, the job modeler 213 receives the command “qsub <filename> <modetype>” and the job script generated in step 20 from the interface node 1. In step 92, the job ID generator 211 checks whether a job ID may be generated. In the present embodiment, the job ID is an ID of the job object assigned to a job object, and numbers in a preset range, for example, some of 1 to 100 are sequentially assigned to the job object, and accordingly, when the numbers in the preset range are all used, an ID of the job object may not be generated.

When an ID of the job object may not be generated as a result of the check in step 92, the processing proceeds to step 93, and if possible, the processing proceeds to step 94. In step 93, the job ID generator 211 initializes a job ID such that a job ID starts from the first number among the numbers in a preset range. For example, the job ID generator 211 may initialize the job ID to “1”. In step 94, the target ID generator 211 generates the job ID with any one of numbers excluding the number previously generated as the target ID.

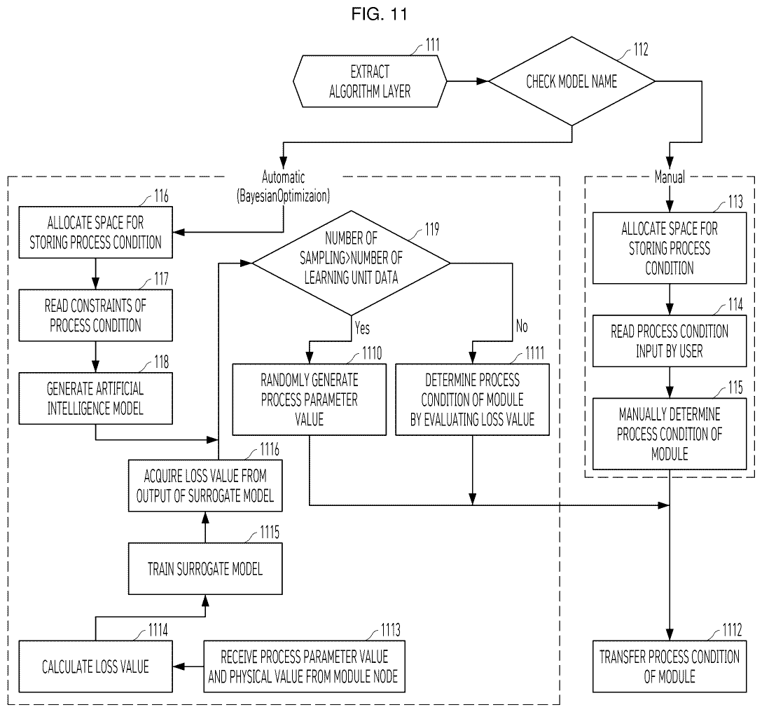

In step 95, the job modeler 213 generates a job object from the job script generated in step 20 and assigns the job ID generated by the job ID generator 211 in step 94 to the job object generated in this way. The job modeler 213 is a model that presents process conditions of an experiment process of each of the multiple modules and generates a model corresponding to the model name recorded in a “model” in the second layer of the algorithm layer of the job script generated in step 20, that is, a model selected according to the information input by a user and generates a process database in which information representing an experiment process of each of the multiple modules selected by the user is recorded, thereby generating a job object including the model generated in this way and the process database. Generating the model of the job object will be described in detail below with reference to FIG. 11.

The job modeler 213 extracts a process layer from the job script generated in step 20. Subsequently, the job modeler 213 reads information representing an experiment process of each of the multiple modules from the extracted process layer and generates a process database including the information representing the experiment process of each of the multiple modules. In the present embodiment, the information representing the experiment process of each of the multiple modules includes an execution sequence of the multiple modules according to the information input by a user, an execution sequence of the multiple tasks for each module, and process conditions fixed by the user. Here, the process conditions fixed by the user refer to process conditions directly input by the user so as not to be changed by the model of the job object, that is, multiple process parameter values.

In step 96, the job modeler 213 maps the job object generated in step 95 and the job ID assigned to the job object to each other and stores the mapped job object and the job ID in a job storage. The job storage is a part of the storage 29 that stores job objects. In step 97, the job modeler 213 stores the job ID generated by the job ID generator 211 in step 94 in a waiting queue. A job ID assigned to each job object is stored in the waiting queue of the present embodiment whenever each job object is generated. Step 91 to step 96 are repeated each time a job script is generated by a user. In this way, the job modeler 213 generates multiple job objects from multiple job scripts and stores multiple job IDs assigned to the multiple job objects in the waiting queue according to a generation sequence of the multiple job objects.

In step 98, the job trigger 212 determines a job ID that satisfies a job object execution condition among multiple job IDs stored in the waiting queue. Here, the job object execution condition for each job ID stored in the waiting queue includes an available resource amount of at least one experimental device used in a module to be first executed among the multiple modules of the job object to which each job ID is assigned, and a condition on whether the module to be first executed owns a task that causes a bottleneck. In step 99, the job trigger 212 checks whether the job ID determined in step 98 exists. When the target ID determined in step 98 exists as a result of the check in step 99, the processing proceeds to step 910. Otherwise, the processing waits until the job ID that satisfies the job object execution condition is determined. In step 910, the job trigger 212 moves the job ID determined in step 98 from the waiting queue to the executing queue and stores the job ID.

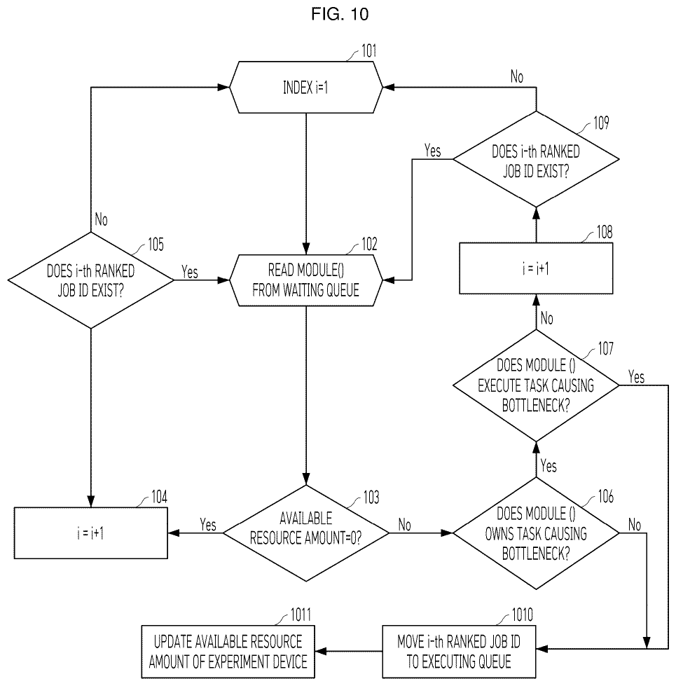

According to the above description, when the job ID stored in the waiting queue does not meet the job object execution condition, the job ID is continuously stored in the waiting queue. As long as at least one job ID is stored in the waiting queue, step 98 to step 910 are continuously repeated, and eventually the job ID satisfies the job object execution condition and is stored in the executing queue. An operation of the job trigger 212 in step 98 to step 910 will be described in detail below with reference to FIG. 10.

By repeating moving, to the executing queue, the available resource amount of at least one experimental device used for the module to be first executed among the multiple modules presented by each job object to which each job ID is assigned among the multiple job IDs stored in the waiting queue and moving, to the executing queue, a job ID first meeting the condition on whether the module to be first executed owns a task causing a bottleneck and storing the available resource amount and the job ID, the job trigger 212 repeats a process of selecting a job object to be first executed among multiple job objects to which the multiple job IDs stored in the waiting queue are assigned.

The job trigger 212 repeats a process of reading the available resource amount of at least one experimental device used in the module to be first executed among the multiple modules presented by each job object to which each job ID is assigned, from the information of each of the multiple module nodes 3 updated by the resource manager 22, and a process of moving, to the executing queue, the job ID that first satisfies the available resource amount read in this way and a condition on whether the module to be first executed owns the task that causes the bottleneck. The job trigger 212 schedules an execution sequence of the multiple job objects generated in step 95 through the repetitive process.

As described above, by scheduling the execution sequence of the multiple job objects by moving the job ID from the waiting queue to the executing queue, a module of a certain job object and a module of another job object may be executed in parallel. As a result, the time required to complete multiple experiments may be significantly reduced.

A job ID that satisfies a job object execution condition among at least one job ID stored in a waiting queue is stored in the executing queue. When a job ID is moved from the waiting queue to the executing queue and stored therein, the job ID is deleted from the waiting queue. When all experiment processes of multiple modules represented by a job object to which a job ID stored in the executing queue is assigned are completed, the job ID is deleted from the executing queue. When at least one job ID is stored in the executing queue, as described below, at least one job object to which the at least one job ID stored in the executing queue is assigned is executed in the order in which the at least one job ID is stored in the executing queue. That is, an experiment process for each of the multiple modules represented by the job object to which each job ID is assigned is performed in the order in which at least one job ID is stored in the executing queue.

In this way, the job trigger 212 schedules an execution sequence of multiple job objects generated in step 95 according to a sequence of satisfying the available resource amount of each of at least one experimental device used in the experiment process of the module to be first executed among the multiple modules presented by each job object to which each job ID is assigned among the multiple job objects generated in step 95 and a condition on whether a module to be first executed owns a task causing a bottleneck. That is, the job trigger 212 schedules an execution sequence of multiple job objects generated in step 95 according to a sequence that satisfies the available resource amount of at least one experimental device used in the experiment process of the module to be first executed among the multiple modules presented by each job object to which the job ID of any one of the multiple job objects generated in step 95 is assigned and a condition on whether a module to be first executed owns a task causing a bottleneck.

In step 911, the job modeler 213 determines process conditions of an experiment process of each of multiple modules presented by a model of a job object to which the job ID stored in the executing queue is assigned as process conditions of an experiment process of each of the multiple modules of the job object generated in step 20. When the job ID stored in the executing queue is a job ID assigned to the job object generated in step 20, the job modeler 213 determines the process conditions of the experiment process of each of the multiple modules presented by the model of the job object to which the job ID stored in the executing queue is assigned as the process conditions of the experiment process of each of the multiple modules of the job object generated in step 20.

According to the above description, a model of the job object is divided into a manual model and an automatic model. When the model of the job object is the manual model, the job modeler 213 determines values of multiple process parameters of each experiment process recorded in the job script generated in step 20 as values of multiple process parameters of each of multiple modules selected by a user. Here, the values of the multiple process parameters of each experiment process recorded in the job script generated in step 20 are process conditions of an experiment process of each of multiple modules presented by the manual model of the job object to which the job ID stored in the executing queue is assigned, and multiple modules selected by a user are the multiple modules indicated by multiple module names recorded in the job script generated in step 20.

When the model of the job object is an automatic model, the job modeler 213 determines values of multiple process parameters of each experiment process predicted by an artificial intelligence model corresponding to the automatic model of the job object generated in step 95 as the values of the multiple process parameters of each experiment process of the multiple modules selected by the user. Here, the values of the multiple process parameters of each experiment process predicted by the artificial intelligence model are process conditions of the experiment process of each of multiple modules presented by the automatic model of a job object to which a job ID stored in an executing queue is assigned, and the multiple modules selected by a user are multiple modules indicated by multiple module names recorded in the job script generated in step 20.

In step 912, the job scheduler 21 reads an execution sequence of multiple modules, an execution sequence of multiple tasks for each module, and process conditions fixed by a user from a process database of a job object to which a job ID stored in an executing queue is assigned. In step 913, the job scheduler 21 transmits all pieces of information of the experiment process of the multiple modules indicated by job objects including process conditions set in step 911, an execution sequence of the multiple modules read in step 912, an execution sequence of multiple tasks for each module, and process conditions. The execution sequence of the multiple modules is expressed in a sequence of multiple module names, an execution sequence of multiple tasks for each module is expressed in a sequence of multiple task names, and the process conditions for each module are expressed as values of multiple process parameters for each module.

FIG. 10 is an operation flowchart of the job trigger 212 illustrated in FIG. 7. Referring to FIG. 10, an operation of the job trigger 212 is performed in a following sequence. In step 101, the job trigger 212 sets a value of an index “i” to an initial value “1”. Here, the index “i” means a rank of a job ID in a waiting queue. When multiple job IDs are stored in the waiting queue, the ranking of each of the multiple job ID is determined in a sequence in which the multiple job IDs are stored. When a certain job ID is deleted from the waiting queue, the rank of the job ID corresponding to a next rank of the job ID is increased by one level.

In step 102, the job trigger 212 reads, from a job storage, a name of the module to be first executed among multiple modules of a job object to which an i-th ranked job ID is assigned in the waiting queue. In the example illustrated in FIG. 10, the name of a module A is read from the job storage. In step 103, the job trigger 212 checks whether an available resource amount of at least one experimental device used in an experiment process of a module having the name read in step 102 is “0”. A condition that the available resource amount of at least one experimental device used in a certain experiment process is “0” is satisfied when an available resource amount of any one of the at least one experimental device used in the experiment process is “0”. When the available resource amount of at least one experimental device used in an experiment process of a module having the name read in step 102 is “0” as a result of the check in step 103, the processing proceeds to step 104. Otherwise, the processing proceeds to step 106.

In step 104, the job trigger 212 increases a value of the index “i” by 1. In step 105, the job trigger 212 checks whether the i-th ranked job ID exists in the waiting queue. When the i-th ranked ID exists as a result of the check in step 105, the processing returns to step 102. When the i-th ranked job ID does not exist, the processing returns to step 101, the index “i” is initialized, and a job object having a job ID corresponding to the first order of the waiting queue is checked again. When the processing returns to step 102, an available resource amount of at least one experimental device to be used for a module to be first executed among multiple modules of a job object to which a job ID of the next order is assigned is checked.

In step 106, the job trigger 212 checks whether a module having the name read in step 102 owns a task that causes a bottleneck. When the module owns the task that causes the bottleneck as a result of the check in step 106, the processing proceeds to step 107. Otherwise, the processing proceeds to step 1010. The bottleneck of the present embodiment means a phenomenon that causes execution delay of another task that is executed subsequently to a certain task as a unit process corresponding to the task consumes the time exceeding a preset threshold time. For example, the bottleneck corresponds to a reaction process that takes a considerable amount of time to complete a chemical reaction desired by a user after several materials are mixed.

In step 107, the job trigger 212 checks whether a module having the name read in step 102 executes a task that causes the bottleneck. When the module executes the task that causes the bottleneck as a result of the check in step 107, the processing proceeds to step 1010. Otherwise, the processing proceeds to step 108. In step 108, the job trigger 212 increases the value of the index “i” by 1. In step 109, the job trigger 212 checks whether the i-th ranked job ID exists in the waiting queue. When the i-th ranked job ID exists as a result of the check in step 109, the processing returns to step 102. When the i-th ranked job ID does not exist, the processing returns to step 101. In step 1010, the job trigger 212 moves the i-th ranked job ID from the waiting queue to the executing queue and stores the i-th ranked job ID. In step 1011, the job trigger 212 instructs the resource manager 22 to update an available resource amount of each experimental device.

According to an operation of the job trigger 212 illustrated in FIG. 10, an execution sequence of multiple job objects is scheduled by considering an available resource amount of at least one experimental device used in a module to be first executed and a condition on whether the module to be first executed owns a task that causes a bottleneck, and thereby, resources of several experimental devices are optimally distributed, and time delays due to the task causing a bottleneck are minimized, and as a result, the time required to complete multiple experiments may be reduced. In addition, by executing lower-priority job objects first in sections that are delayed due to a bottleneck of a certain task, the time required to complete multiple experiments may be further reduced.

FIG. 11 is an operation flowchart of the job modeler 213 illustrated in FIG. 7. Referring to FIG. 11, an operation of the job modeler 213 proceeds in a following sequence. In step 111, the job modeler 213 extracts an algorithm layer from the job script generated in step 20. In step 112, the job modeler 213 checks a model name recorded in a “model” in the second layer of the algorithm layer extracted in step 111. When the model name recorded in “model” is “Manual” as a result of the check in step 112, the processing proceeds to step 113, and when the model name recorded in “model” is “Automatic”, the processing proceeds to step 116.

In step 113, the job modeler 213 allocates some storage spaces of the storage 29 to a job ID assigned to the job object in step 95 as a space for storing process conditions of an experiment process of each of multiple modules of a job object to which a job ID is assigned in step 95. The storage space allocated in this way becomes a use space of the job object to which the job ID is assigned. In step 114, the job modeler 213 reads the process conditions input by a user from the algorithm layer extracted in step 111. The process conditions input by a user include, for example, the total number of experiments and values of multiple process parameters that the user wants to experiment with.

In step 115, the job modeler 213 generates a manual model corresponding to the model name recorded in “model” in the second layer of the algorithm layer extracted in step 111 and determines the process conditions read in step 114 as process conditions of an experiment process for each of multiple modules of the job object to which the job ID is assigned in step 95 according to the manual model generated in this way. In the present embodiment, the manual model is a kind of mapping function that maps one-to-one multiple process parameter values to multiple process parameter values of an experiment process for each of multiple modules of the job object to which the job ID is assigned in step 95.

In step 116, the job modeler 213 allocates some storage space of the storage 29 as a space for storing process conditions of an experiment process for each of multiple modules of a job object to which a job ID is assigned in step 95 in the job ID allocated to the job object in step 95. In step 117, the job modeler 213 reads constraints of the process conditions set by a user from the algorithm layer extracted in step 111. The constraints of the process conditions set by a user include a range of the process parameter values set by a user among pieces of the information recorded in the job script illustrated in FIGS. 5A and 5B, a value of a process parameter that the user unconditionally wants to execute, and a range of constraints in a process design based on an artificial intelligence model.

In step 118, the job modeler 213 generates an artificial intelligence model corresponding to a model name recorded in “model” in the second layer of the algorithm layer extracted in step 111. The job modeler 213 may generate an artificial intelligence model by copying the artificial intelligence model corresponding to the model name recorded in “model” in the second layer of the algorithm layer among several types of artificial intelligence models stored in the storage 29. The artificial intelligence model copied in this way is an artificial intelligence model before optimization according to the present embodiment. Next, the job modeler 213 reads a value of a hyperparameter for optimizing the artificial intelligence model generated in this way from the algorithm layer extracted in step 111.

Hyperparameter values for optimizing an artificial intelligence model include pieces of information recorded in, for example, “batchSize”, “totalCycleNum”, “verbose”, “randomState”, “sampling”, and “samplingMethod”, “samplingNum”, “acqMethod”, “acqSampler”, “acqhyperparamater”, and “lossMethod”, “lossTarget”, and “Property” among pieces of information recorded in the job script illustrated in FIGS. 5A and 5B. When the model name recorded in “model” in the second layer of the algorithm layer extracted in step 111 is “BayesianOptimization”, the job modeler 213 generate an artificial intelligence model by copying a surrogate model and acquisition function stored in the storage 29. Hereinafter, the present embodiment will be described by assuming that an artificial intelligence model including the surrogate model and acquisition function is generated.

In step 119, the job modeler 213 compares the number of sampling among the hyperparameter values read in step 118 with the number of learning unit data accumulated in the storage 29 until now. When the number of sampling is greater than the number of learning unit data accumulated in the storage 29 until now as a result of the comparison in step 119, the processing proceeds to step 1110. When the number of learning unit data accumulated in the storage 29 until now is greater than the number of sampling as a result of the comparison in step 119, the processing proceeds to step 1111.

In step 1110, the job modeler 213 randomly generates multiple process parameter values within a range that satisfies constraints of the process conditions read in step 117 and determines the multiple process parameter values generated in this way as process conditions of an experiment process for each of multiple modules of a job object to which a job ID is assigned in step 95. For example, the job modeler 213 generates multiple sets of multiple process parameters within a range of a process parameter value set by a user for at least one physical property value recorded in “Property” of the job script generated in step 20.

In step 1111, the job modeler 213 determines ranks of multiple loss values calculated in step 1116 by evaluating the multiple loss values calculated in step 1116 by using the acquisition function. Subsequently, the job modeler 213 determines the multiple process parameter values corresponding to the highest loss among the multiple losses calculated in step 1116 among the multiple sets of the multiple process parameter values generated in step 1116 as process conditions of an experiment process for each of the multiple modules of a job object to which a job ID is assigned in step 95.

In step 1112, the job modeler 213 transmits the process conditions of the experiment process for each of the multiple modules of the job object to which the job ID is assigned in step 95 to the task generator 23. In step 1113, when the job modeler 213 receives a combination of the multiple process parameter values and at least one physical property value from the module node 3 through the packet receiver 28, the job modeler 213 stores the combination of the multiple process parameter values and at least one physical property value received in this way in the storage 29 as new unit data for learning. Here, the at least one physical property value includes, for example, current density, absorbance, and so on, and is changed depending on the type of measurement module or analysis module that outputs the at least one physical property value.

In step 1114, the job modeler 213 extracts a learning unit data having at least one physical property value corresponding to the at least one physical property value recorded in “Property” of the job script generated in step 20 among the multiple pieces of learning unit data stored in the storage 29, and calculates a loss value between the at least one physical property value of the learning unit data extracted in this way and the at least one physical property value recorded in “Property” of the job script generated in step 20 by using a loss function of “lossMethod” in the job script generated in step 20.

In step 1115, the job modeler 213 inputs multiple process parameter values of the learning unit data extracted in step 1114 to the surrogate model of the automatic model generated in step 118, and trains the surrogate model such that the loss value calculated in step 1114 is output from the surrogate model to which the multiple process parameter values are input.

In step 1116, the job modeler 213 generates multiple sets of the multiple process parameter values that satisfy the constraints of the process conditions read in step 117 for the at least one physical property value recorded in “Property” of the job script generated in step 20 For example, the job modeler 213 generates multiple process parameters, which may be obtained, within a range of process parameter values set by a user for the at least one physical property value recorded in “Property” of the job script generated in step 20. Each set of the multiple process parameter values includes multiple process parameter values of several experiment processes for acquiring at least one physical property value recorded in “Property” of the job script generated in step 20. Subsequently, the job modeler 213 inputs each set of the multiple process parameters values generated in this way to the surrogate model, repeats the process of acquiring the loss of each set from an output of the surrogate model, thereby acquiring multiple loss values for multiple sets of the multiple process parameter values.

The resource manager 22 periodically receives, from each of the multiple module nodes 3 through the packet receiver 28, information of each of the multiple module nodes 3 including an available resource amount of at least one experimental device used in the experiment process of each module performed by each of the multiple module nodes 3, experimental device setting information, and experimental device state information. The resource manager 22 updates the available resource amount of at least one experimental device used in the experiment process of each module performed by each of the multiple module nodes 3, the experimental device setting information, and the experimental device state information according to the information of each of the multiple module nodes 3 periodically received in this way, thereby continuously managing the available resource amount, the setting information, and the state information of all experimental devices with the latest information.

The resource manager 22 may request the information of each of the multiple module nodes 3 to each of the multiple module nodes 3 when receiving an update instruction on the information of each of the multiple module nodes 3 from the job scheduler 21. In this case, each of the multiple module nodes 3 transmits the information of each of the multiple module nodes 3 according to the request of the resource manager 22, and the resource manager 22 updates the information on each of the multiple module nodes 3 according to the information on each of the multiple module nodes 3 transmitted in this way. When there is a request from the job scheduler 21, the task generator 23, and the task scheduler 24, the resource manager 22 transmits the available resource amount of each experimental device, the settings information, and the state information to the job scheduler 21, the task generator 23, and the task scheduler 24.

The task generator 23 generates multiple task recipes corresponding to recipes of multiple unit processes of an experiment process of each of multiple modules for each job object for each of the multiple modules for each job object based on process conditions presented by a model of each job object generated by the job scheduler 21, process conditions fixed by a user among pieces of information recorded in a process database of each job object, and setting information of each experimental device updated by the resource manager 22. In this way, the task generator 23 generates a task recipe for each task name recorded in the process database of each job object. Here, the multiple modules for each job object are the multiple modules selected by each user for each job object and refer to the multiple modules indicated by multiple module names recorded in the process database of each job object.

What experimental device is used for the unit process corresponding to each task and through what procedures the experiment is performed are stored in each of the multiple module nodes 3 for each task name. Therefore, when the process conditions for each task are determined, each task may be executed by each of the multiple module nodes 3. For example, assuming there is a job object that executes a “Batch Synthesis”→“UV-Vis” module, a task sequence of the “Batch Synthesis” module is recorded in the process database, and has a sequence “Add Solution”→“Heat”→“React”. First, the information that has to be recorded in an “Add Solution” task includes a reagent name, reagent volume, reagent concentration, and reagent discharge speed. The task generator 23 generates a task recipe of “Add Solution” by searching for the relevant information from the process conditions presented by the model of each job object and the process conditions fixed by a user among pieces of information recorded in the process database of each job object.

The information to be recorded in a “Heat” task includes heating temperature. The task generator 23 generates a task recipe of “Heat” by searching for the relevant information from the process conditions presented by the model of each job object and the process conditions fixed by a user among pieces of process information recorded in the process database of each job object. The information to be recorded in a “React” task includes heating time. The task generator 23 generates a task recipe of “React” by searching for the relevant information from the process conditions presented by the model of each job object and the process conditions fixed by a user among pieces of information recorded in the process database of each job object.

A task sequence of a “UV-Vis” module is recorded in the process database and has a sequence of “PrepareSample”→“GetAbsorbance”. First, the information to be recorded in a “Prepare Sample” task includes the type and amount of samples. The task generator 23 generates a task recipe of “Prepare Sample” by searching for the relevant information from the process conditions presented by the model of each job object and the process conditions fixed by a user among pieces of information recorded in the process database of each job object. The information to be recorded in a “Get Absorbance” task includes a measurement hyperparameter. The task generator 23 generates a task recipe of “Prepare Sample” by searching for the relevant information from the process conditions presented by the model of each job object and the process conditions fixed by a user among pieces of information recorded in the process database of each job object.

The task scheduler 24 schedules an execution sequence of tasks based on an execution sequence of tasks for each module among pieces of information recorded in the process database of each job object, and advances or stops the execution of each task according to each of the multiple task recipes generated for each of the multiple modules of each job object according to the available resource amount of at least one experimental device used in the experiment process of each of the multiple modules of each job object and the experimental device state information. The task scheduler 24 determines whether to execute each of the multiple task recipes generated by the task generator 23 for each job object generated by the job scheduler 21, based on the available resource amount of each experimental device updated by the resource manager 22 and the experimental device state information.

The task scheduler 24 checks a state of at least one experimental device to be used in the module to be first executed among the multiple modules of each job object. When the state of at least one experimental device to be used in the module to be first executed among the multiple modules of a certain job object is abnormal as a result of the checking, the task scheduler 24 temporarily stops execution of the job object. Otherwise, the task scheduler 24 checks the available resource amount of at least one experimental device used in the module to be first executed among the multiple modules of each job object. An abnormal state of an experimental device may include, for example, a failure of the experimental device.

As a result of checking the available resource amount of at least one experimental device used in the module to be first executed among the multiple modules of each job object, when the available resource amount of at least one experimental device to be used in the module to be first executed among the multiple modules of a certain job object is “0”, the task scheduler 24 temporarily stops execution of the job object. Here, stopping the execution of a job object means stopping execution of all tasks of multiple modules of the job object.

Otherwise, the task scheduler 24 checks whether the number of experiments to be executed in the job object is greater than the available resource amount of at least one experiment device to be used in the module to be first executed. When the number of experiments to be executed in the job object is less than the available resource amount of at least one experimental device to be used in the module to be first executed as a result of the checking, the task scheduler 24 allocates a resource amount to be consumed by the task among the available resource amount of the experimental device to the task of the module to be first executed, and determines execution of the task.

When the number of experiments to be executed in the job object is greater than the available resource amount of at least one experiment device to be used in the module to be first executed, the task scheduler 24 performs a comparison process with the available resource amount described above for each of at least one job object that is previously stopped and determines whether to execute a task recipe for each of at least one previously stopped job object according to the result. The above-described process is repeated for the next module to be executed subsequently to the module to be first executed among the multiple modules of the job object.

The action translator 25 determines multiple actions of at least one experimental device used in each task recipe according to a resource amount of at least one experimental device allocated to each task determined to be executed by the task scheduler 24 and the process conditions recorded in the task recipe of each task determined to be executed by the task scheduler 24. The action of an experimental device refers to an action to be set according to the resource amount allocated to each task and the process conditions recorded in the task recipe. In this way, the action translator 25 serves to translate a unit process of each task into multiple actions by dividing the unit process of each task into actions of at least one experimental device used to execute each task.

For example, a task “Add Solution” in a “Batch Synthesis” module is divided into three actions: pump initialization→solution dispenser movement→pump discharge. The task information and resources recorded in the task recipe are distributed to the three actions. In a pump initialization action, a pump address value is used for an experimental device setting value recorded in an “AddSolution” task recipe. Next, a solution dispenser movement action uses a location information on a resource amount received from the resource manager 22. Next, a pump discharge action uses a solution type, a solution volume, a solution concentration, and a solution discharge speed value recorded in the “AddSolution” task recipe. Information required to perform an action in a task recipe, that is, a process of extracting action information is preset for each task and stored in each of the multiple module nodes 3. As described above, each action information is determined according to the resource amount allocated to each task and the process conditions recorded in the task recipe.

The action scheduler 26 schedules an execution sequence of multiple actions according to whether the same experimental device is used simultaneously in an execution process of different job objects and whether movement lines of different experimental devices overlap in the execution process of different job objects. Here, the simultaneous execution of different job objects means that an experiment process of a certain module of a certain job object and ab experiment process of a certain module of another job object are performed simultaneously. This situation may occur when both a module to be first executed in a certain job object and a module to be first executed in a certain job object meet job object execution conditions without a large time difference. A case where the movement lines of several different experimental devices overlap each other includes, for example, a case where two robot arms collide with each other.

First, the action scheduler 26 receives states of all experimental devices of a specific module including the action to be currently performed from the resource manager 22. Next, the action scheduler 26 checks an experimental device required to perform a corresponding action. Next, the action scheduler 26 checks whether the checked experimental device and the currently operating experimental device are the same as each other and whether the movement lines overlap each other. When the experimental device checked in this way and the experimental device currently in operation are the same as each other or overlap each other in movement line, the action scheduler 26 stops a corresponding action and waits until the problem is resolved. Otherwise, the action scheduler 26 transmits the information on the corresponding action to the packet transmitter 27. Each action information transmitted to the packet transmitter 27 includes a job ID, at least one experimental device name, respective action names, respective pieces of action information, and a mode type.

The packet transmitter 27 collects the at least one experimental device name, the respective action names, the respective pieces of action information, and the mode type for each ID from various types of action information received from the action scheduler 26. Subsequently, the packet transmitter 27 generates multiple packets including combinations of a job ID, at least one experimental device name, multiple action names, multiple pieces of action information, and the mode type, and transmits the multiple packets generated in this way to each of the multiple module nodes 3 through a network based on transmission control protocol/internet protocol (TCP/IP) communication. The packet in the present embodiment refers to a packet with a TCP/IP format.

Each of the multiple module nodes 3 receives the multiple packets from the master node 2 through a network based on the TCP/IP communication, and extracts combinations of the job ID, the at least one experimental device name, the multiple action names, the multiple pieces of action information, and the mode type from the multiple packets received in this way. Here, the job ID is a job ID assigned to each job object, and the at least one experimental device name is at least one name of an experimental device used in the experiment process of each of the multiple modules of each job object. The multiple action names are multiple action names listed according to an execution sequence of multiple actions scheduled by the action scheduler 26, the multiple pieces of action information correspond to information for executing the multiple actions, and the mode type indicates whether an experiment is a virtual experiment or a real experiment.

Among the multiple module nodes A to H, the module node 3, which performs an experiment process of a certain module among multiple modules of each job object, receives, from the master node 2, multiple action names listed according to an execution sequence of multiple actions for each task of the module and information for performing actions corresponding to the multiple action names and executes the actions corresponding to the multiple action names in a sequence in which the multiple action names are listed, according to the information for executing the actions corresponding to the multiple action names, thereby performing an experiment process of a module.

When completing the experiment process of each module, each of the multiple module nodes 3 generates a combination of multiple process parameter values used in performing the experiment process of each module and at least one physical property value corresponding to the performance result of the experiment process of each module, as a result of the experiment process of each module, and generates multiple packets including the combination of the multiple process parameter values and at least one physical property value. Subsequently, each of the multiple module nodes 3 transmits the multiple packets generated in this way to the master node 2 through the network based on the TCP/IP communication. In addition, each of the multiple module nodes 3 periodically transmits, to the master node 2 through the TCP/IP communication, the information of each of the multiple module nodes 3 including an available resource amount for at least one experimental device used in the experiment process of each module performed by each of the multiple module nodes 3, experimental device setting information, and experimental device state information.

The packet receiving unit 28 receives multiple packets from each of the multiple module nodes 3 through the network based on the TCP/IP communication, and extracts a combination of multiple process parameter values and at least one physical property value from the multiple received packets or extracts information of each of the multiple module nodes 3 including an available resource amount of at least one experimental device used in an experiment process of each module, experimental device setting information, and experimental device state information. The combination of the multiple process parameter values and at least one physical property value is stored in the storage 29. The information of each of the multiple module nodes 3 is transmitted to the resource manager 22. The interface node 1 may output the combination of the multiple process parameter values and at least one physical property value to a user, and the master node 2 may use the combination to train a surrogate model.

By performing an experiment process for each of the multiple modules for each job object according to an execution sequence of multiple job objects generated from multiple job scripts in which names of the multiple modules selected by a user are recorded, based on process conditions of an experiment process of each of the multiple modules presented by each job object, an experiment desired by the user may be performed automatically without the user's involvement by simply selecting some of the multiple modules obtained by modularizing multiple unit processes performed in a laboratory by grouping the multiple unit processes.

By scheduling an execution sequence of multiple job objects based on an available resource amount of at least one experimental device used in an experiment process of a module to be first executed among multiple modules of each job object, resources of the several experimental devices provided in a laboratory may be optimally distributed and used such that multiple experiments desired by several users may be completed quickly.

By scheduling an execution sequence of multiple job objects according to a sequence that satisfies an available resource amount of at least one experimental device used in an experiment process of a module to be first execute for the multiple job objects and a condition on whether the module to be first executed owns a task causing a bottleneck, time delay due to the task causing the bottleneck may be minimized, and accordingly, the time required to complete multiple experiments may be reduced.

By scheduling an execution sequence of multiple job objects in a method of repeating a process of storing multiple job IDs assigned to the multiple job objects in a waiting queue according to a generation sequence of the multiple job objects and moving, to an executing queue, a job ID that first satisfies a condition for an available resource amount of at least one experimental device used in the module to be first executed among the multiple modules of each job object among the multiple job IDs stored in the waiting queue and storing the job ID, a module of a certain job object and a module of another job object may run executed in parallel. As a result, the time required to complete multiple experiments may be significantly reduced.

In particular, by scheduling an execution sequence of multiple job objects in a method of repeating a process of moving, to an executing queue, a job ID that first satisfies an available resource amount for at least one experimental device used for a module to be first executed among multiple job IDs stored in a waiting queue and a condition on whether the module to be first executed owns a task causing a bottleneck and storing the job ID, the job objects with lower priorities may be first executed in sections where there is a delay due to a bottleneck in a certain task. As a result, the time required to complete multiple experiments may be further reduced. Effects of the present disclosure are not limited to the effects described above, and another effect may be derived from the descriptions above.

Meanwhile, the laboratory operation method according to the embodiment of the present disclosure described above may be implemented by a program executable on a processor of a computer and may be implemented on a computer that records and executes the program on a computer-readable recording medium. The computer includes all types of computers that may execute programs, such as a desktop computer, a notebook computer, a smartphone, and an embedded-type computer. In addition, a structure of the data used in one embodiment of the present disclosure described above may be recorded on a computer-readable recording medium through various means. The computer-readable recording medium includes a storage, such as random access memory (RAM), read only memory (ROM), a magnetic storage medium (for example, a floppy disk, a hard disk, or so on), or an optical reading medium (for example, compact disk (CD)-ROM, a digital video disk (DVD), or so on).

So far, the present disclosure is described by using preferred embodiments. Those skilled in the art to which the present disclosure pertains will be able to understand that the present disclosure may be implemented in a modified form without departing from the essential characteristics of the present disclosure. Therefore, the disclosed embodiments should be considered from an illustrative point of view rather than a limiting point of view. The scope of the present disclosure is described in the claims rather than the foregoing description, and all differences within the equivalent scope have to be construed as being included in the present disclosure.

What is claimed is:

1. A laboratory operation system comprising:
an interface node configured to generate a job script that records name of each of multiple modules selected by a user among multiple modules into each of which multiple unit processes performed in a laboratory, is modularized as each experiment process by grouping the multiple unit processes;
a master node configured to generate multiple job objects corresponding to multiple job scripts from the multiple job scripts including the generated job script and schedule an execution sequence of the generated multiple job objects; and
multiple module nodes configured to perform the experiment process of each of the multiple modules for each of the multiple job objects based on process conditions of the experiment process of each of the multiple modules presented by each of the multiple job objects according to the execution sequence of the multiple job objects.

2. The laboratory operation system of claim 1, wherein
the master node schedules the execution sequence of the generated multiple job objects based on an available resource amount of at least one experimental device used in an experiment process of a module to be first executed among the multiple modules of the multiple job objects.

3. The laboratory operation system of claim 2, wherein
the master node schedules the execution sequence of the generated multiple job objects according to a sequence in which the generated multiple job objects satisfy a condition for an available resource amount of at least one experimental device used in the experiment process of the module to be first executed.

4. The laboratory operation system of claim 3, wherein
the master node schedules the execution sequence of the generated multiple job objects according to a sequence in which the generated multiple job objects satisfy a condition for the available resource amount of the at least one experimental device used in the experiment process of the module to be first executed and whether the module to be first executed owns a task causing a bottleneck.

5. The laboratory operation system of claim 3, wherein
the master node includes a job scheduler configured to schedule the execution sequence of the generated multiple job objects in a method of repeating a process of storing multiple job identifications (IDs) assigned to the multiple job objects in a waiting queue according to a generation sequence of the multiple job objects, and moving, to an executing queue, a job ID that first satisfies the condition for the available resource amount of at least one experimental device used in the module to be first executed among multiple IDs stored in the waiting queue, and
at least one job object to which at least one job ID stored in the executing queue is assigned is executed in a sequence in which the at least one job ID is stored in the executing queue.

6. The laboratory operation system of claim 5, wherein
the job scheduler includes a job trigger configured to schedule the execution sequence of the generated multiple job objects in a method of repeating a process of moving, to the executing queue, a job ID that first satisfies the condition on an available resource amount of at least one experimental device used for the module to be first executed among the multiple IDs stored in the waiting queue and whether the module to be first executed owns a task causing a bottleneck.

7. The laboratory operation system of claim 5, further comprising:
a resource manager configured to receive, from each of the multiple module nodes, information of each module node including an available resource amount of at least one experiment device used in the experiment process of each of the multiple modules performed by each of the multiple module nodes and configured to update the available resource amount of the at least one experimental device used in the experiment process of each of the multiple modules performed by each of the multiple module nodes according to the received information of the each module node,
wherein the job scheduler repeats a process of reading the available resource amount of the at least one experimental device used for the module to be first executed from the information of the each module node updated by the resource manager, and moving a job ID that first satisfies a condition for the read available resource amount to the executing queue.

8. The laboratory operation system of claim 1, wherein
the interface node selects a model presenting a process condition of the experiment process of each of the selected multiple modules according to information input by a user and generates the job script that records the process condition of the experiment process according to the selected model, and
the master node generates a job object including the selected model and determines the process condition of the experiment process of each of the multiple modules presented by the model included in the generated job object as a process condition of an experiment process of each of the multiple modules of the generated job object.

9. The laboratory operation system of claim 8, wherein,
when the selected model is a manual model that manually determines the process condition of the experiment process of each of the selected multiple modules and presents the manually determined process condition, the master node determines values of multiple process parameters of each experiment process recorded in the generated job script as values of multiple process parameters of the experiment process of each of the selected multiple modules.

10. The laboratory operation system of claim 8, wherein,
when the selected model is an automatic model that automatically determines the process condition of the experiment process of each of the selected multiple modules and presents the automatically determined process condition, the master node determines values of multiple process parameters of each experiment process predicted by an artificial intelligence model corresponding to the automatic model as values of multiple process parameters of the experiment process of each of the selected multiple modules.

11. The laboratory operation system of claim 10, wherein
the master node includes a job scheduler configured to generate the selected model, generate a process database in which information representing the experiment process of each of the selected multiple modules is recorded, and generate a job object including the generated model and the generated process database, and
the information representing the experiment process of each of the selected multiple modules includes an execution sequence of the multiple modules and an execution sequence of multiple tasks for each module according to the information input by the user.

12. The laboratory operation system of claim 11, wherein the master node further includes:
a task generator configured to generate multiple task recipes corresponding to recipes of multiple unit processes corresponding to the experiment process of each of the selected multiple modules for each of the selected multiple modules based on the process condition presented by the model of the generated job object and information recorded in a process database of the generated job object; and
a task scheduler configured to perform or stop a unit process according to each of the multiple task recipes generated for each of the multiple selected modules according to the available resource amount of the at least one experimental device used in the experiment process of each of the selected multiple modules.

13. The laboratory operation system of claim 11, wherein the master node further includes:
a task generator configured to generate a task recipe corresponding to a recipe of each of the multiple unit processes of the experiment process of each of the selected multiple modules for each of the multiple tasks for each module based on the process condition presented by the model of the generated job object and information recorded in a process database of the generated job object; and
a task scheduler configured to determine execution or stop of each task according to each of the multiple task recipes generated for each of the selected multiple modules according to the available resource amount of the at least one experimental device used in the experiment process of each of the selected multiple modules.

14. The laboratory operation system of claim 13, wherein the master node further includes:
an action translator configured to determine multiple actions of at least one experimental device used in the each task recipe according to a resource amount of at least one experimental device allocated to each task determined by the execution and a process condition recorded in a task recipe of each task determined by the execution; and
an action scheduler configured to schedule an execution sequence of the determined multiple actions according to whether identical experimental devices are used simultaneously during execution of different job objects.

15. The laboratory operation system of claim 14, wherein
one module node that performs an experiment process of one module among the multiple modules of the each job object among the multiple module nodes, performs an experiment process of the one module by receiving multiple action names listed according to the execution sequence of the multiple actions and information for performing actions corresponding to the multiple action names for each task of the one module from the master node, and by executing the actions corresponding to the multiple action names in a sequence in which the multiple action names are listed, according to the information for executing the actions corresponding to the multiple action names.

16. A laboratory operation method comprising:
generating a job script that records name of each of multiple modules selected by a user among multiple modules into each of which multiple unit processes performed in a laboratory, is modularized as each experiment process by grouping the multiple unit processes;
generating multiple job objects corresponding to multiple job scripts from the multiple job scripts including the generated job script and scheduling an execution sequence of the generated multiple job objects; and
performing the experiment process of each of the multiple modules for each of the multiple job objects based on process conditions of the experiment process of each of the multiple modules presented by each of the multiple job objects according to the execution sequence of the multiple job objects.

17. A computer-readable recording medium in which a program causing a computer to execute the laboratory operation method of claim 16 is recorded.
